(19) United States
(12) Patent Application Publication
(10) Pub. No.: US 2015/0061238 A1
(43) Pub. Date: Mar. 5, 2015

(54) POSITIONING BOARD OF CHUCK

(71) Applicant: Cherng Jin Technology Co., Ltd., Changhua County (TW)

(72) Inventor: Chien-Chih Lin, Changhua County (TW)

(73) Assignee: CHERNG JIN TECHNOLOGY CO., LTD., Changhua County (TW)

(21) Appl. No.: 14/017,066

(22) Filed: Sep. 3, 2013

(51) Int. Cl. B23B 31/02

(52) U.S. Cl. CPC B23B 31/021; B23B 2231/04; B23B 2240/00
USPC 279/142

(57) ABSTRACT

A positioning board for a chuck includes a board member with a central bore, positioning bores and positioning slots. Each positioning slot has a main slot and two sub-slots connected to opposite ends of the main slot to form an H-shaped slot. Two flexible tongues are formed at opposite sides of the main slot. Therefore, while a post of a base engages the positioning slot, the flexible tongues are bent by the post to provide a precise engagement of chuck's bases.

### BACKGROUND OF THE INVENTION

1. Technical Field

The present invention relates to a machine tool, and more particularly to a positioning board of a chuck.

2. Description of Related Art

In the field of machine tool, a conventional electrode chuck usually has a first base and a second base. The first base is affixed to the machine tool, and the second base is designed to hole an object. Typically, the electrode chuck may hold different objects, so that there usually are a plurality of different second bases to hold different objects. These second bases are able to engage and disengage the first base. For repeated engagement and disengagement, the wearing between the first and second base will cause a loose engagement of the second base with the first base, and the loose engagement will decrease the precision of the machine tool.

Typically, a positioning board is provided between the first base and the second base to fix the problem of loose engagement. FIG. 1 shows a conventional positioning board 1, which has several bores 1a to engage posts 2a of a first base 2 and a plurality of elongated slots 1b to engage posts 3a of a second base 3. The posts 3a of the second base 3 are flat, and a thickness thereof gradually reduces from a root to a tip thereof. With such posts 3a and the elongated slots 1b, it may correct the position of the second base 3 in the engagement with the first base 2.

In order to correct the position of the second base 3, the positioning board must be a rigid board with a predetermined thickness. Such positioning board, however, will cause a friction between the posts 3a and sidewalls of the elongated slots 1b. As a result, referring to FIG. 2, each post 3a only have a short potion received in the slot 1b that is insufficient for a stable engagement of the second base 3. Besides, each post 3a only has a side contacting the sidewall of the slot 1b , and there is a gas G left between the other side of the post 3a and the other sidewall of the slot 1b. The gaps are bad for the precise engagement as well.

### BRIEF SUMMARY OF THE INVENTION

In view of the above, the primary objective of the present invention is to provide a positioning board of a chuck, which provides precise engagement of the bases of the chuck.

In order to achieve the objective of the present invention, a positioning board for a chuck includes a board member with a positioning bore and a positioning slot. The positioning slot has a main slot and a first sub-slot connected to an end of the main slot, and the sub-slot is not parallel to the main slot.

The positioning slot of the positioning board provides a precise engagement of the first base with the second base.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the conventional chuck;

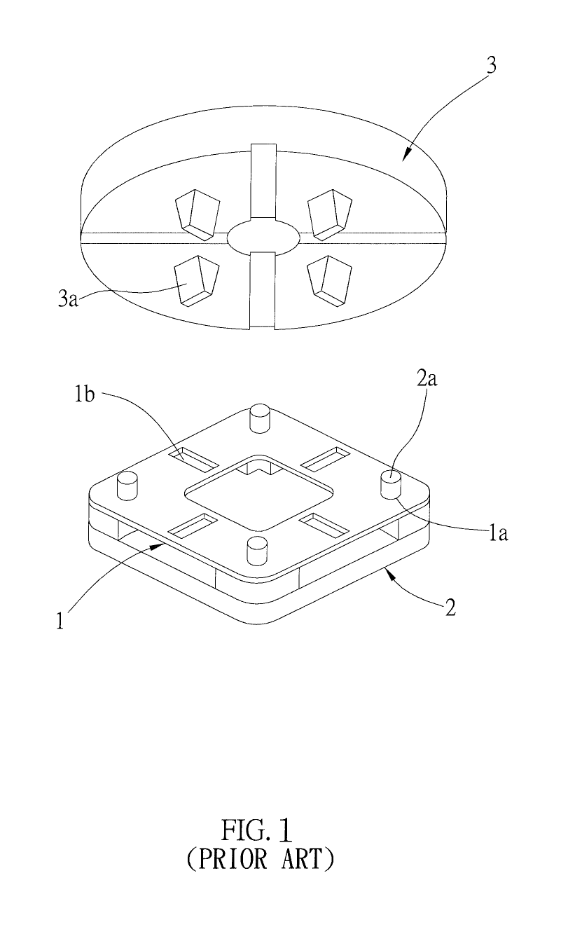

FIG. 2 is a sectional view of the conventional chuck, showing the engagement of the positioning board with the second base;

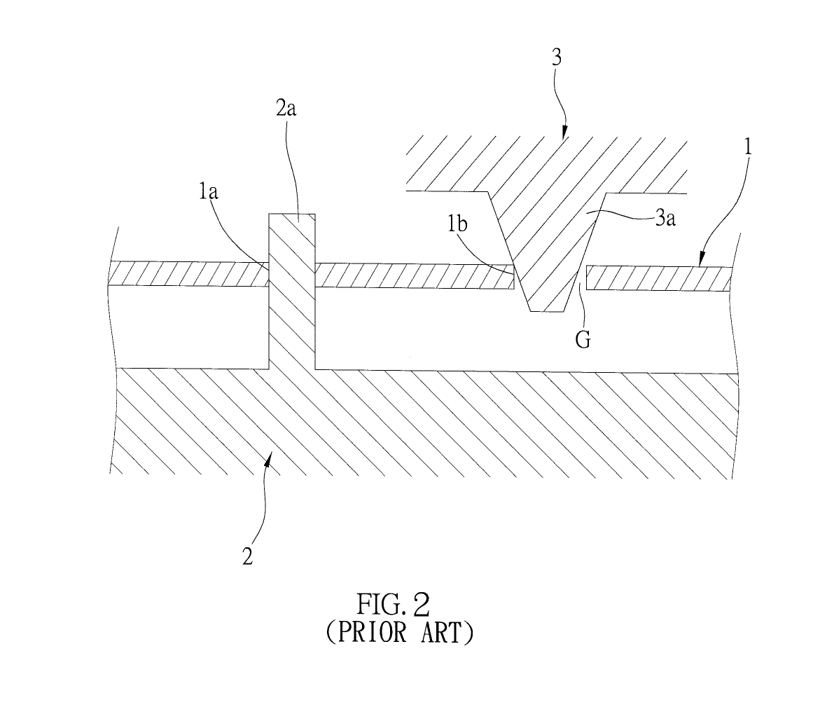

FIG. 3 is a perspective view of a first preferred embodiment of the present invention;

FIG. 4 is a sectional view of the first preferred embodiment of the present invention, showing the engagement of the positioning board with the second base;

FIG. 5 is a sectional view of a second preferred embodiment of the present invention, showing the engagement of the positioning board with the second base;

FIG. 6 is a sectional view of a third preferred embodiment of the present invention, showing the engagement of the positioning board with the second base; and

FIG. 7 is a perspective view of the third preferred embodiment of the present invention.

### DETAILED DESCRIPTION OF THE INVENTION

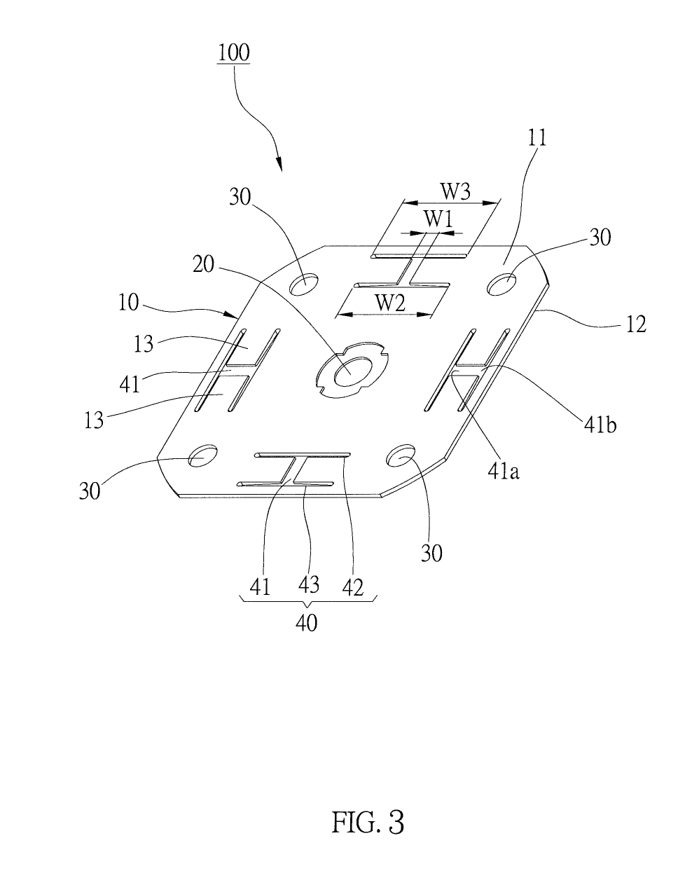

FIG. 3 shows a positioning board 100 of the first preferred embodiment of the present invention, which includes a board member 10 with a central bore 20, a plurality of positioning bores 30, and a plurality of positioning slots 40.

The board member 10 is a rectangular rigid board with a predetermined thickness. The board member 10 has a first side 11 and a second side 12 opposite to the first side 11.

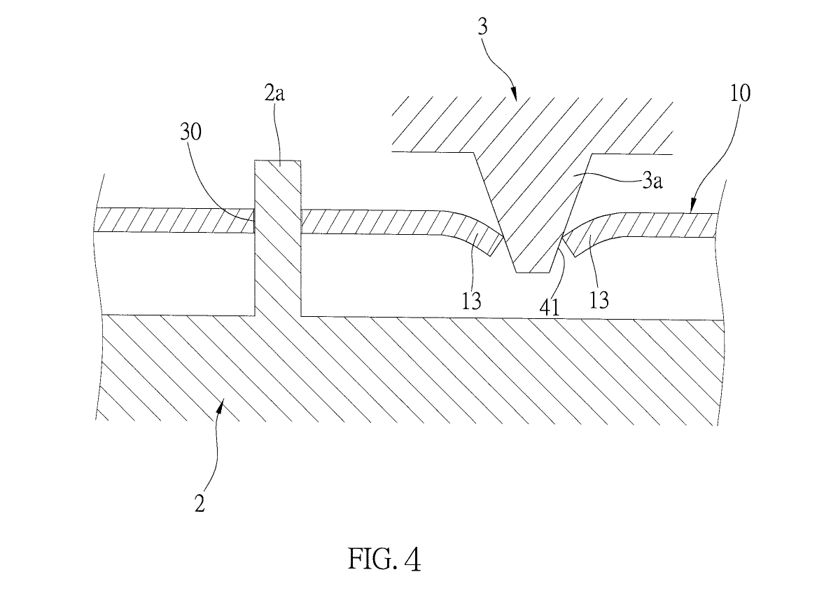

The central bore 20 is a round though hole at a center of the board member 10, and the positioning bores 30 are four round though holes at corners of the board member 10. As shown in FIG. 4, the positioning board 100 is provided between a first base 2 and a second base 3 of a chuck. The first base 2 has several posts 2a for engagement with the positioning bores 30 of the positioning board 100 respectively to firmly affix the board member 10 to the first base 2.

The positioning slots 40 are elongated through holes at a margin of the board member 10. The positioning slots 40 are aligned with posts 3a of the second base 3 respectively. Each positioning slot 40 has a main slot 41, a first sub-slot 42 and a second sub-slot 43. The main slot 41 is designed for engaging the post 3a. The main slot 41 has a first end 41a and a second end 41b. The first sub-slot 42 is parallel to the second sub-slot 43, and both of them are perpendicular to the main slot 41. The first sub-slot 42 is connected to the first end 41a of the main slot 41, and the second sub-slot 43 is connected to the second end 41b. As shown in FIG. 3, the main slot 41 is connected to middle of the first and the second sub-slots 42, 43, so that the positioning slots 40 are H-shaped slots, and two flexible tongues 13 are formed at opposite sides of the main slot 41. Precisely, a width of the main slot 41 is W1, a length of the first sub-slot 42 is W2, and a length of the second sub-slot 43 is W3. W2 and W3 are equal to or greater than twice of W1. In an embodiment, W1 is 5 mm, and W2 and W3 are 10 mm. It provides the flexible tongues 13 a suitable flexibility.

As shown in FIG. 4, the posts 3a of the second base 3 are aligned with the main slots 41 of the positioning slots 40 and engage the main slots 41 respectively while the second base 3 is moved toward the first base 2. At the same time, the post 3a bends the flexible tongues 13, and is squeezed into the main slot 41. The flexible tongues 13 provide no gap between the posts 3a and the sidewalls of the positioning slots 40 to give a precise engagement of the first base 2 with the second base 3.

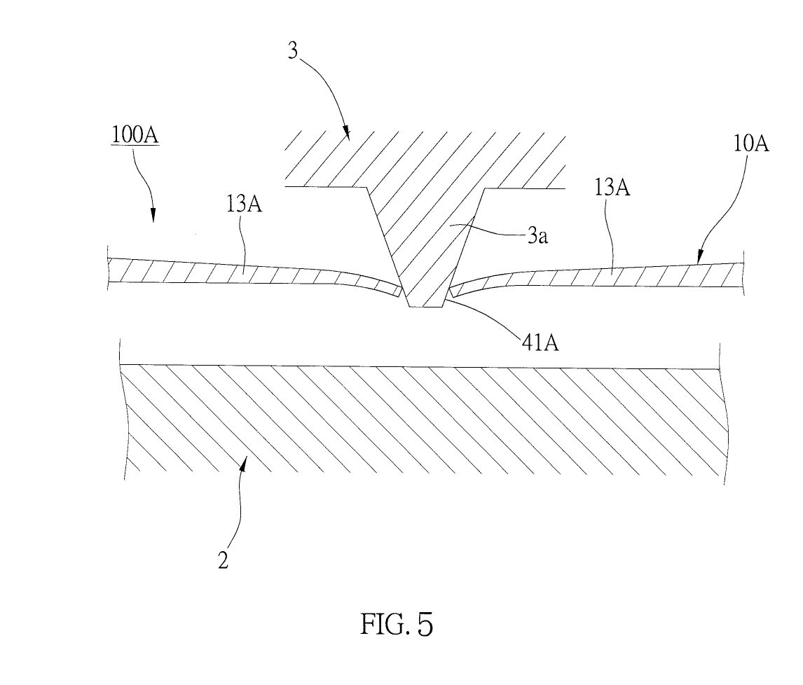

FIG. 5 shows a positioning board 100A of the second preferred embodiment of the present invention, which is similar to the first preferred embodiment, except that a thickness of each flexible tongue 13A on a board member 10A gradually reduces from a root to a distal end thereof. In other words, the thickness of each flexible tongue 13A is gradually thinner towards a main slot 41A. Therefore, the flexible tongue 13A has a high flexibility at the distal end and a high rigidity at the root. It may provide a precise and firm positioning function.

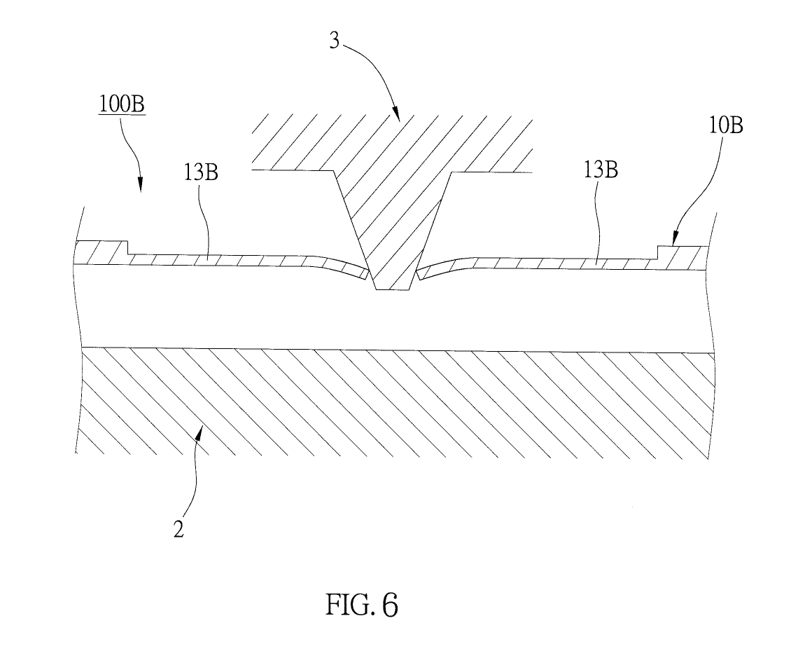

FIG. 6 shows a positioning board 100B of the third preferred embodiment of the present invention, which is similar to the first and the second preferred embodiments, except that each flexible tongue 13B on a board member 10B has an even thickness and is thinner a thickness of the board member 10B. The positioning board 100B of the third preferred embodiment has the same function as above.

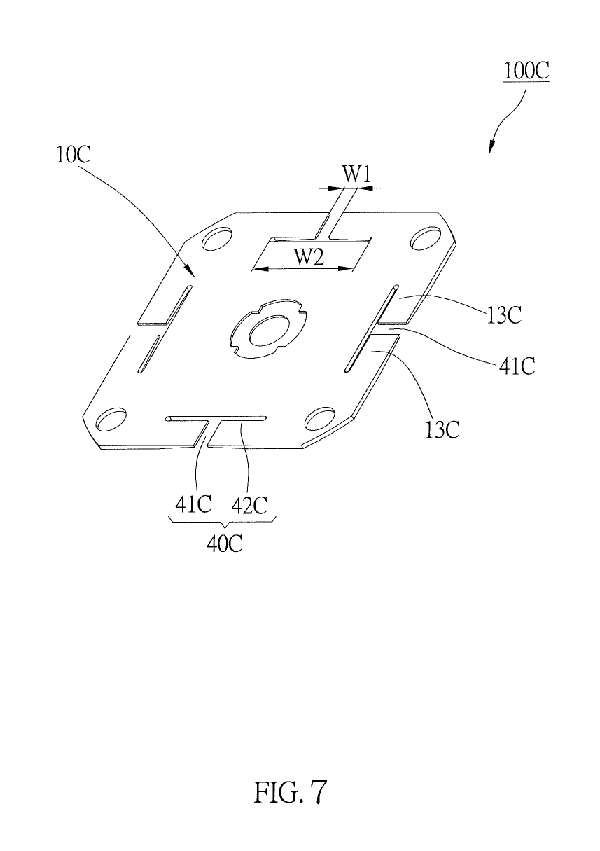

FIG. 7 shows a positioning board 100C of the fourth preferred embodiment of the present invention, which is similar to the first preferred embodiment, except that a board member 10C has a plurality of T-shaped positioning slots 40C. Each positioning slot 40C has a main slot 41C and a sub-slot 42C at an end of the main slot 41C. The other end of the main slot 41C extends to an edge of the board member 10C, so that two flexible tongues 13C are formed for each positioning slot 40C. A width of the main slot 41 C is W1, and a length of the sub-slot 42C is W2. W2 is greater than or equal to twice of W1. It provides the flexible tongues 13C a predetermined flexibility for the same purpose as above. The flexible tongues 13C may have a gradually reduced thickness or an even thickness as shown in FIG. 5 and FIG. 6.

It must be pointed out that the embodiments described above are only some preferred embodiments of the present invention. All equivalent structures which employ the concepts disclosed in this specification and the appended claims should fall within the scope of the present invention.

What is claimed is:

1. A positioning board for a chuck, comprising:
a board member, which has a first side and a second side opposite to the first side, having a positioning bore and a positioning slot, both of which are open at the first side and the second side;
wherein the positioning slot has a main slot and a first sub-slot connected to an end of the main slot, and the sub-slot is not parallel to the main slot.

2. The positioning board of claim 1, wherein the first sub-slot is perpendicular to the main slot.

3. The positioning board of claim 2, wherein the main slot is connected to a middle of the first sub-slot, and the main slot has an end, which is opposite to the end of the main slot connected to the first sub-slot, extending to an edge of the board member, so that two flexible tongues are formed at opposite sides of the main slot.

4. The positioning board of claim 3, wherein each flexible tongue has an even thickness, and the thickness of the flexible tongue is thinner than that of the board member.

5. The positioning board of claim 3, wherein each flexible tongue has a root and a distal end adjacent to the main slot, and a thickness of the flexible tongue gradually reduces from the root to the distal end.

6. The positioning board of claim 3, wherein a length of the first sub-slot is greater than or equal to twice of a width of the main slot.

7. The positioning board of claim 3, wherein the positioning slot further has a second sub-slot connected to an end of the main slot, which is opposite to the end of the main slot connected to the first sub-slot, and the second sub-slot is not parallel to the main slot.

8. The positioning board of claim 7, wherein the second sub-slot is parallel to the first sub-slot, and both the first sub-slot and the second sub-slot are perpendicular to the main slot.

9. The positioning board of claim 8, wherein the main slot is connected to middles of the first sub-slot and the second sub-slot, so that two flexible tongues are formed at opposite sides of the main slot.

10. The positioning board of claim 9, wherein each flexible tongue has an even thickness, and the thickness of the flexible tongue is thinner than that of the board member.

11. The positioning board of claim 9, wherein each flexible tongue has a root and a distal end adjacent to the main slot, and a thickness of the flexible tongue gradually reduces from the root to the distal end.

12. The positioning board of claim 9, wherein a length of the first sub-slot is greater than or equal to twice of a width of the main slot, and a length of the second sub-slot is greater than or equal to twice of the width of the main slot.
